(19) United States
(12) Patent Application Publication
(10) Pub. No.: US 2025/0315228 A1
(43) Pub. Date: Oct. 9, 2025

(54) COMPILER METHOD AND APPARATUS FOR IDENTIFYING DYNAMIC SINGLE-USE PRODUCING DEFINITIONS IN PROGRAMS

(71) Applicant: Samsung Electronics Co., Ltd., Gyeonggi-do (KR)

(72) Inventors: Frederick C. CHOW, Fremont, CA (US); Timothy KONG, San Jose, CA (US)

(21) Appl. No.: 18/883,679

(22) Filed: Sep. 12, 2024

Related U.S. Application Data
(60) Provisional application No. 63/574,939, filed on Apr. 5, 2024.

(51) Int. Cl. G06F 8/41

(52) U.S. Cl. CPC G06F 8/43

(57) ABSTRACT

A method, apparatus, and system are disclosed. The method includes constructing a static single assignment (SSA) form and a static single use (SSU) form for a program; setting a single-use disqualifying property locally for each SSU version, and propagating the single-use disqualifying property both forward and backward on an SSU graph uniquely formed from the constructed SSU form so it becomes a global property; transferring results from the SSU form to the SSA form to set a single-use property locally for each SSA version based on an occurrence of any use being associated with a disqualifying SSU version; performing data flow analysis on an SSA graph uniquely formed from the constructed SSA form so the single-use property becomes a global property to identify one or more definitions as dynamic single-use for variables in the program; and generating computer-readable instructions for executing the program based on the one or more definitions identified as dynamic single use for the variables in the program, wherein the one or more definitions identified as dynamic single-use has a defined value used exactly one time during execution of the program.

### CROSS-REFERENCE TO RELATED APPLICATION

This application claims the priority benefit under 35 U.S.C. § 119(e) of U.S. Provisional Application No. 63/574,939, filed on Apr. 5, 2024, the disclosure of which is incorporated by reference in its entirety as if fully set forth herein.

### TECHNICAL FIELD

The disclosure generally relates to compiler technology. More particularly, the subject matter disclosed herein relates to improvements to methods and apparatuses for identifying dynamic single-use producing definitions in computer programs.

### SUMMARY

The execution of computer programs written in imperative programming languages involves storing data into program variables and later referencing these variables. This is also true at the machine code level, where a program has been compiled into instructions corresponding to the processor's instruction set architecture (ISA). Typically, the result of each instruction is defined (stored) into a register, and the defined value is later used as operands in further computations. Modern processors can exploit the knowledge of values defined to be used only once during execution to improve run-time performance and reduce power consumption. For optimization in this regard, the compiler should identify and mark these “used once” (or “single-use”) definitions to enable such hardware improvements. This “used once” qualification is dynamic, in the sense that it is an execution time characterization in the order that instructions are fetched and executed. This is in contrast to the static designation, which refers to the relative positioning of the definitions and uses when the program is stored in memory.

This problem is solved when both the definition and its single use are within the same basic block (a straight-line sequence of instructions). However, when control flow (branches and joins) exists between the definition and its single use, compilers frequently resort to pattern matching to detect dynamic single-use definitions.

Pattern matching requires an ever-increasing set of patterns to cover more cases, which slows down the compilation process and increases the compiler's memory footprint. No collection of patterns can guarantee detection of all dynamic single-use definitions in all programs.

To overcome these types of issues, systems and methods are described herein that can identify all dynamic single-use producing definitions in a program both within and across basic blocks using a data flow propagation approach. This introduces the concept of a static single use (SSU) form, which is the dual of a static single assignment (SSA) form, to capture dynamic single-use properties. The method may involve one or more of the following steps: constructing an SSA form and performing dead store elimination, building an SSU form on top of the resulting SSA form, initializing arrays to track disqualifying uses in the constructed SSU form and single-use definitions in the constructed SSA form, and propagating data flow properties stored in these arrays with respect to the constructed SSU and SSA forms to accurately identify all dynamic single-use definitions.

The above approaches improve upon previous methods because they provide a systematic and comprehensive way to identify all dynamic single-use definitions across the entire program. The method is efficient, as it operates with linear complexity and does not introduce significant computational overhead beyond typical compilation tasks. By marking more definitions accurately, the method enables processors to optimize run-time performance and reduce power consumption effectively, thus enhancing overall system efficiency.

In an embodiment, a method is provided. The method includes constructing an SSA form and an SSU form for a program; setting a single-use disqualifying property locally for cach SSU version, and propagating the single-use disqualifying property both forward and backward on an SSU graph uniquely formed from the constructed SSU form so it becomes a global property; transferring results from the SSU form to the SSA form to set a single-use property locally for each SSA version based on an occurrence of any use being associated with a disqualifying SSU version; performing data flow analysis on an SSA graph uniquely formed from the constructed SSA form so the single-use property becomes a global property to identify one or more definitions as dynamic single-use for variables in the program; and generating computer-readable instructions for executing the program based on the one or more definitions identified as dynamic single use for the variables in the program, wherein the one or more definitions identified as dynamic single-use has a defined value used exactly one time during execution of the program.

In an embodiment, an apparatus is provided. The apparatus includes a processor; and a memory storing instructions that, when executed by the processor, cause the apparatus to construct an SSA form and an SSU form for a program; set a single-use disqualifying property locally for each SSU version, and propagate the single-use disqualifying property both forward and backward on an SSU graph uniquely formed from the constructed SSU form so it becomes a global property; transfer results from the SSU form to the SSA form to set a single-use property locally for each SSA version based on an occurrence of any use being associated with a disqualifying SSU version; perform data flow analysis on an SSA graph uniquely formed from the constructed SSA form so the single-use property becomes a global property to identify one or more definitions as dynamic single-use for variables in the program; and generate computer-readable instructions for executing the program based on the one or more definitions identified as dynamic single use for the variables in the program, wherein the one or more definitions identified as dynamic single-use has a defined value used exactly one time during execution of the program.

In an embodiment, a system is provided. The system includes a processor configured to execute instructions to construct an SSA form and an SSU form for a program; set a single-use disqualifying property locally for each SSU version, and propagate the single-use disqualifying property both forward and backward on an SSU graph uniquely formed from the constructed SSU form so it becomes a global property; transfer results from the SSU form to the SSA form to set a single-use property locally for each SSA version based on an occurrence of any use being associated with a disqualifying SSU version; perform data flow analysis on an SSA graph uniquely formed from the constructed SSA form so the single-use property becomes a global property to identify one or more definitions as dynamic single-use for variables in the program; and generate computer-readable instructions for executing the program based on the one or more definitions identified as dynamic single use for the variables in the program, wherein the one or more definitions identified as dynamic single-use has a defined value used exactly one time during execution of the program.

### BRIEF DESCRIPTION OF THE DRAWING

In the following section, the aspects of the subject matter disclosed herein will be described with reference to exemplary embodiments illustrated in the figures, in which:

FIG. 1 illustrates a deployment in a compilation process, according to an embodiment;

FIG. 2A illustrates a raw representation of definition-use relations, according to an embodiment;

FIG. 2B illustrates a representation of definition-use relations in an SSA form, according to an embodiment;

FIG. 2C illustrates a representation of the same definition-use relations of FIG. 2B but in the form of a graph, according to an embodiment;

FIG. 3 is a table summarizing the differences and illustrating the dual nature between an SSA form and an SSU form, according to an embodiment;

FIG. 4 illustrates an SSU form constructed on top of an SSA form, according to an embodiment;

FIG. 5 is a flowchart illustrating a method for identifying dynamic single-use producing definitions in a program, according to an embodiment;

FIG. 6 is a control flow diagram illustrating SSA and SSU forms for the given program, according to an embodiment;

FIG. 7 is a control flow diagram illustrating SSA and SSU forms for the given program, according to an embodiment;

FIGS. 8A-8B are control flow diagrams illustrating SSA and SSU forms for the given programs, according to various embodiments;

FIGS. 9A-9B are control flow diagrams illustrating SSA and SSU forms for the given programs, according to various embodiments;

FIGS. 10A-10C are control flow diagrams illustrating SSA and SSU forms for the given programs, according to various embodiments; and

FIG. 11 illustrates a block diagram of an electronic device configured to implement a method and system for identifying dynamic single-use producing definitions in a program, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The present disclosure introduces a method and apparatus that can be implemented by a compiler, designed to enhance the identification of dynamic single-use producing definitions across program basic blocks, each basic block being a sequence of instructions without internal branch. The method can be applied to “a definition”, which may represent one or more (e.g., all) definitions in a program to maximize efficiency. This method leverages an SSA form, a widely used form of intermediate representation in compilers where each variable (e.g., a symbolic name associated with a storage location in memory) is assigned exactly once, and an SSU form, a form developed and applied in this solution. An SSU form is the dual of SSA, focusing on uses instead of definitions and capturing the single-use properties of variables and registers in a program.

By constructing an SSU form on top of an SSA form, the embodiments disclosed herein facilitate a comprehensive data flow analysis that propagates the single-use property throughout the program. The process begins with the elimination of dead stores, followed by the insertion of λ functions at control flow split points in an SSU form. These functions help in tracking the flow of data and identifying disqualifying uses that prevent a definition from being single-use. Through an efficient propagation mechanism, the method accurately marks definitions that are used exactly once during execution, enabling the generation of optimized machine instructions that can be exploited by modern processors to improve performance and reduce power consumption.

One innovative aspect of this invention lies in its ability to perform global analysis across multiple basic blocks. This comprehensive approach ensures that all potential single-use definitions are identified, providing significant benefits in terms of execution efficiency and energy savings. The method is implemented with linear complexity, making it suitable for integration into existing compiler frameworks without adding significant overhead.

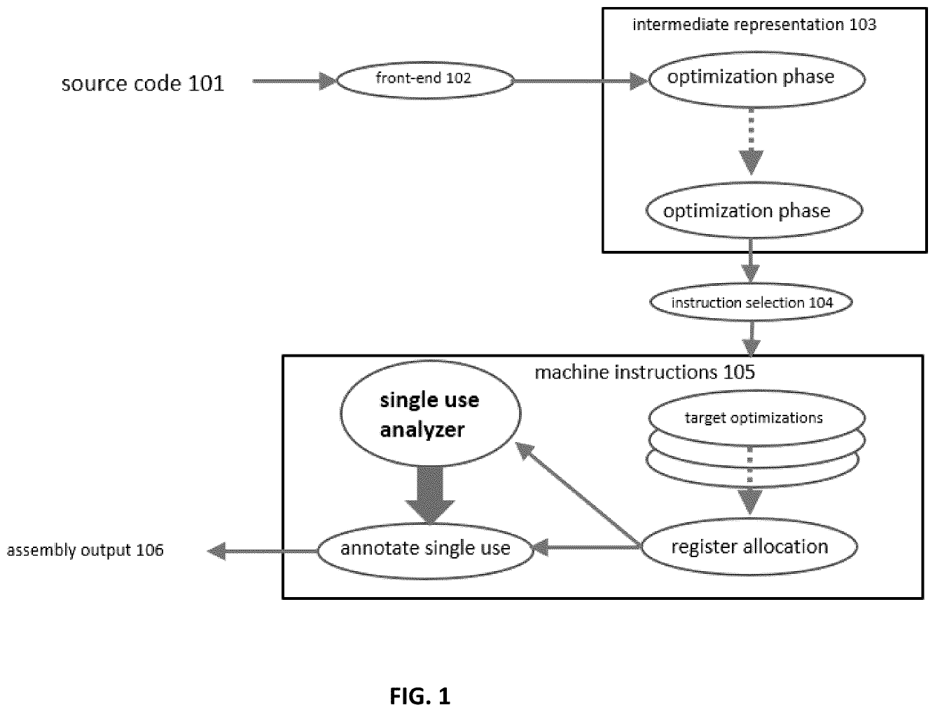

FIG. 1 illustrates a deployment in a compilation process, according to an embodiment.

More specifically, FIG. 1 illustrates a compilation process, which transforms source code written in a high-level programming language into machine code that can be executed by a computer. Other compilation processes may be used. FIG. 1 is divided into several stages, each represented by specific components and reference numerals to detail the flow of data and operations in the compilation process.

Referring to FIG. 1, the process begins with the source code 101, which is the initial input to the compiler and includes the high-level programming language code. Source code typically includes constructs like variables, functions, and control flow statements that are human-readable.

The front-end 102 of the compiler is responsible for parsing the source code. The result is an intermediate representation 103 of the program that is easier for the subsequent stages of the compiler to work with.

The intermediate representation is the result of transforming the source code into a lower-level, machine-independent code. The intermediate representation serves as a bridge between the high-level source code and the machine-specific code, allowing various optimizations to be applied in a way that is abstracted from the specifics of the target machine. During the optimization phases, various optimization techniques are applied to the intermediate representation to improve the performance and efficiency of the resulting code. These machine-independent optimizations can include removing redundant code, inlining functions, loop unrolling, and other transformations that enhance execution speed and reduce resource consumption.

Following machine-independent optimizations, the compilation process moves to instruction selection 104, which involves converting the optimized intermediate representation into specific machine instructions. Instruction selection maps the intermediate representation to the actual instructions supported by the target processor's instruction set architecture (ISA).

The generated machine instructions 105 (e.g., computer-readable instructions) represent the actual commands that will be executed by the processor. Many target-specific optimizations are applied to the machine instructions. They include register allocation and a single-use analyzer. Register allocation assigns variables to processor registers, minimizing the need for slower memory accesses. The single-use analyzer, which is a component introduced by this disclosure, identifies definitions that are dynamically used exactly once. Finally, the assembly output 106 is produced, which corresponds to the machine code that will be directly executed by the computer's processor.

Compilers face challenges in identifying all single-use producing definitions within the program being compiled. Most compilers limit their analysis and detection capabilities to straight-line pieces of code, known as basic blocks, where the analysis is relatively straightforward. However, when control flow features such as branches and joins exist between a definition and its single use, there is no known technique to solve this problem efficiently and optimally. As a result, compilers often resort to pattern matching.

For pattern matching, there is no finite number of possible patterns that can cover all the possible situations, leading to the necessity for an ever-increasing set of patterns to achieve broader coverage. This approach results in significant problems, including the failure to discover all single-use producing definitions, severe compile-time overhead incurred by the pattern matching process, and an increased memory footprint for the compiler due to the need to store a large number of patterns. These issues highlight the limitations and inefficiencies of current methods in identifying dynamic single-use definitions across complex control flows in programs.

A compiler is a software program executed on a hardware device that translates programs written in high level languages into the lower-level form that can be executed directly. In the compilation process, the program representation is continuously being transformed. At some point in the compilation process, the compiler builds a control flow graph (CFG) representation of the program to represent all possible flows of control.

A CFG is a graphical representation of all paths that might be traversed through a program during its execution. In the context of compiler design and optimization, a CFG is used to model the flow of control within a program, enabling the analysis and transformation of the program's structure.

The nodes in a CFG represent basic blocks, which are straight-line code sequences with no branches except at the entry and exit. Each basic block contains a sequence of instructions or statements that are executed sequentially. The edges in the CFG represent the control flow paths between these basic blocks, indicating the possible transitions from one block to another based on the program's logic and branching conditions.

A definition-use (also referred to as “def-use”) represents the flow of data from where a variable is defined to where the variable is used. In general, a variable x has many points in the program where it is defined and many points in the program where it is used. Any valid flow of data between a definition and a use constitutes a definition-use and must be represented and taken into account in any transformation performed by the compiler, because transformations that do not preserve definition-use relations are likely incorrect transformations. One way to represent definition-use is to create edges among these definitions and uses. For example, if there are m definitions and n uses of variable x, this will result in up to m*n definition-use edges being created.

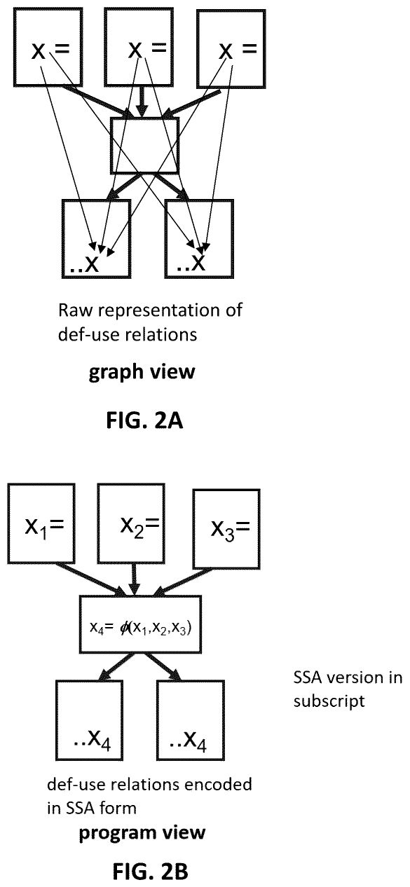

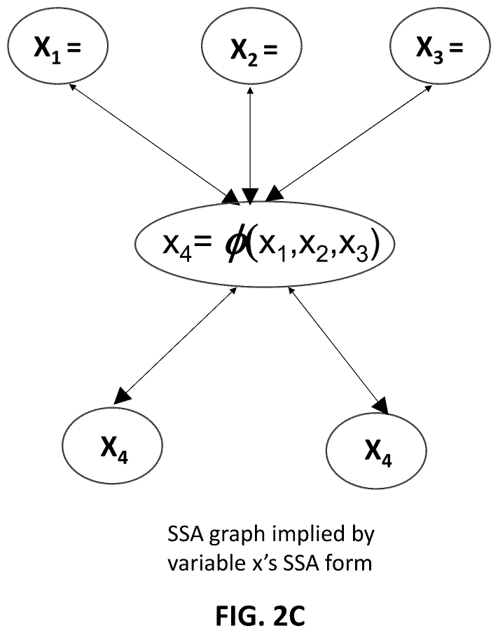

FIG. 2A illustrates a raw representation of definition-use relations, according to an embodiment.

Referring to FIG. 2A, the diagram shows the raw representation of definition-use relations without SSA. In a program, each variable or machine register can be defined multiple times and used multiple times. The raw representation creates a complex and dense graph where each use of a variable must be connected to every definition that reaches it. For example, if there are three definitions and two uses of a variable x, this results in up to six definition-use edges being created. This is depicted in the graph view of FIG. 2A, where multiple arrows represent the connections between definitions and uses (definition-uses). Because value flows from definitions to their uses, in a definition-use edge, its arrow points from the definition towards the use. Such a representation with so many definition-use edges is inefficient and difficult to manage. Any valid flow of data between a definition and a use constitutes a definition-use and should be preserved during any transformation performed by the compiler to ensure correctness. This approach of representing these relationships leads to increased compile-time overhead and a larger memory footprint for the compiler. It also does not provide the points in the CFG where values from multiple definitions intersect.

Instead, most modern compilers use an SSA form to represent definition-use. In an SSA form, definition-use edges are factored at control flow merge (or convergence) points. To represent this factoring, SSA introduces the ϕ function at any program point reached by multiple definitions of the variable. ϕ itself is a def, and it denotes the semantics of merging the different values of the variable from the multiple definitions, which are the ϕ operands. The use represented by each ϕ operand is regarded as occurring at the exit of its corresponding predecessor block.

FIG. 2B illustrates a representation of definition-use relations in an SSA form, according to an embodiment.

Referring to FIG. 2B, the diagram shows an SSA form, which captures the definition-use relations in a structured and optimized manner. In an SSA form, a unique version is used to annotate each definition of the variable. SSA versions are conventionally annotated with subscripts. An SSA form addresses the data flow problem by ensuring cach variable version is assigned exactly once and using ϕ functions to merge values at control flow join points (e.g., locations in a program where multiple control flow paths converge into a single path, typically arising from conditional statements or loops). FIG. 2B shows three initial definitions: x₁, x₂, and x₃. These definitions converge into a ϕ function (x₁,x₂,x₃), producing x₄. The ϕ function represents the merging of different values from multiple definitions, ensuring that any subsequent use of x₄ can be traced back to one of the original definitions x₁, x₂, or x₃, depending on the control flow path taken. This approach simplifies the tracking of variable values and reduces the complexity of data flow analysis.

SSA's factoring operation provides several advantages. The number of definition-use edges is reduced, and any use of the variable must be defined by a single-definition. This enables the use of a unique variable version to annotate each definition and all its uses. The definition-use relationships are built into the variable version annotation, so the definition-use edges do not need to be represented explicitly. Because any use can have only a single definition, any definition in SSA must dominate (i.e., the definition must precede and be on every control flow path to any of its uses within the program, ensuring that the value assigned by the definition is always the one used) all its uses. All uses of the same variable version are of the same value because their value is defined by the same definition. When the compiler analyzes the flow of data in a variable, it only needs to consider its SSA representation instead of the entire CFG.

FIG. 2C illustrates a representation of the same definition-use relations of FIG. 2B but in the form of a graph, according to an embodiment.

Referring to FIG. 2C, because cach definition-use relation can be conceived as an edge in a graph, with the definition and the use being the two nodes connected by the edge, the definition-use relations in an SSA form of a variable always form a graph, with the ϕ function acting as the connection nodes. This may be referred to as an SSA graph. When applying one or more embodiments of the present disclosure, only a single SSA graph may be used, though the graph may consist of unconnected components.

FIGS. 2A, 2B, and 2C are different ways to represent the definition-use relations in a program. FIG. 2A shows a raw representation, where each use of a variable is connected to every possible definition, resulting in a high number of edges. It does not provide the points in the CFG where multiple values merge. In contrast, FIG. 2B demonstrates a representation using an SSA form, where each variable version is assigned exactly once, and the ϕ function merges values at control flow join points, thus representing the points in the program where the variable's value changes due to control flow merges. Because an SSA form captures only the points in the program where the variable changes value, it is sparse relative to the CFG. Analysis performed on SSA is much more efficient than on the CFG because the sparseness means fewer number of nodes to visit.

An SSU form is introduced as a form that enables a method to determine the single-use property of variables in a program. An SSU form is the dual of SSA, focusing on the use side of the definition-use relationship. The construction of an SSU form involves the insertion of λ functions at control flow split points (e.g., locations in a program where a single control flow path diverges into multiple paths, typically associated with conditional statements or loops), similar to the ϕ functions used in an SSA form. These λ functions represent the diversion of defined values to multiple paths.

In an SSU form, each use of a variable is given a unique version number (this may be referred to as an “SSU version”, which is distinct from “SSA version”), and the multiple definitions reaching each use are assigned the same SSU version number. This allows for precise tracking of the single-use property, as any definition in an SSU form can only flow to its first use. When a definition reaches multiple first uses due to a control flow split, a λ function is inserted to represent this divergence. The process of constructing an SSU form is similar to that of an SSA form but with an inverted view of the CFG. Furthermore, because cach definition-use relation can be conceived as an edge in a graph, with the definition and the use being the two nodes connected by the edge, the definition-use relations in an SSU form of a variable always forms a graph, with the λ function acting as the connection nodes. This may be referred to as an SSU graph. When applying one or more embodiments of the present disclosure, only a single SSU graph may be used, though the graph may consist of unconnected components.

Both SSA graphs and SSU graphs are directed graphs because all their edges are uni-directional, pointing from definitions to uses. When a property (also referred to as an attribute) is locally established (or initialized) at a node, the property can be propagated to adjacent nodes. Propagation that follows the direction of the edge is called forward propagation, while propagation that moves in the opposite direction to the edge is called backward propagation. Data flow propagation refers to the iterative process of propagating the property across all nodes in the graph, ensuring that the property is no longer limited to its initial settings but applies to the entire graph, ultimately yielding a global impact.

In the context of this Application, two key properties are considered: the single-use disqualifying property applied to SSU versions and the single-use property applied to SSA versions. Both the single-use disqualifying property for SSU versions and the single-use property for SSA versions are intended to be global properties. Initially, these properties are set based on local conditions at individual nodes (referred to as initial or local settings), and then data flow propagation converts these properties from their initial local state to their final global state.

The process of data flow propagation involves forward and backward propagation of these initial settings throughout the SSU and SSA graphs. For instance, if a Boolean property is initialized as true or false at a node, and the property is then established based on conditions present at that node, it must be propagated through the graph to ensure that the property becomes global. This propagation process has linear complexity, as each node is updated at most once, making it efficient for large programs.

The use of an SSU form, according to various embodiments disclosed herein, is built on an SSA form, ensuring that definitions and uses in ϕ functions are also marked with SSU versions. However, in the λ functions inserted during SSU construction, no SSA version is needed. The λ functions enable the propagation of the disqualifying property forward and backward at split points. Accordingly, the term “disqualifying” is used to describe an SSU version that leads to the disqualification of an SSA version from single-use. An SSU version is considered disqualifying if it meets certain conditions (such as having a λ operand or no valid definition). The term “disqualified” is used to describe an SSA version that has been determined to not be single-use. An SSA version is disqualified if any of its corresponding SSU versions at its uses are disqualifying.

By using an SSU form, the compiler can more effectively identify non-single-use occurrences (additional uses after the first use), which are then transferred to the SSA form. SSU enables the compiler to accurately identify dynamic single-use definitions.

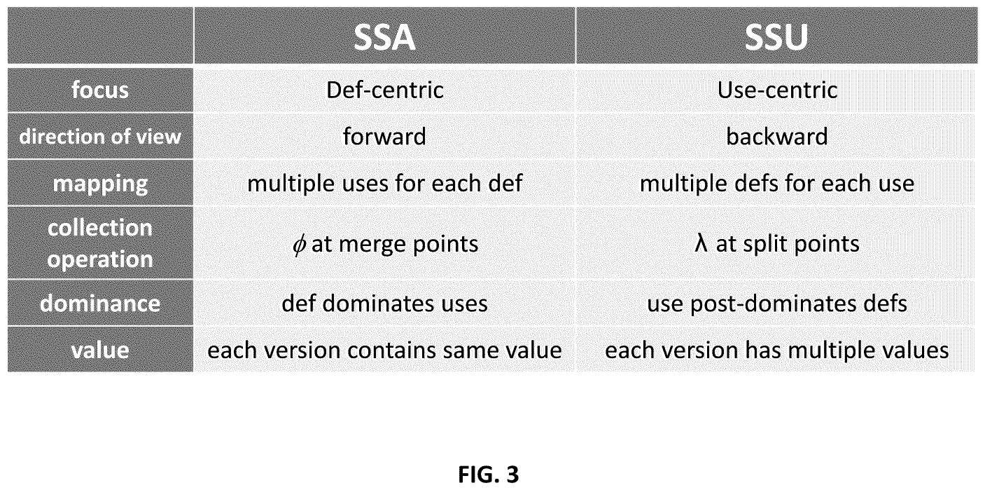

FIG. 3 is a table summarizing the differences and illustrating the dual nature between an SSA form and an SSU form, according to an embodiment.

Referring to FIG. 3, SSA is definition-centric, meaning it focuses on the definitions of variables, whereas SSU is use-centric, focusing on the uses of variables.

The direction of reasoning for SSA is forward, which means it tracks the flow of data from definitions to their subsequent uses. In contrast, SSU reasons in a backward direction, tracking the flow from uses back to their originating definitions.

SSA maps multiple uses to a single definition. This means a single definition can be referenced multiple times. SSU, on the other hand, maps multiple definitions to a use.

The factoring operation in SSA involves the introduction of ϕ at merge points in the CFG to reconcile different values coming from multiple control flow paths into a single variable version. Conversely, SSU employs λ at split points, which manages the distribution of a defined value to multiple divergent control paths.

In an SSA form, a definition dominates all its uses. In an SSU form, a use post-dominates all the definitions that define its value.

The value of each version in SSA contains the same value because it is defined by a single definition. In SSU, each version can have multiple values as it aggregates all the definitions that flow into a particular use.

According to an embodiment, the method may begin by building SSA of the program variables that are targets for the dynamic single-use identification. Because ϕ in SSA does not appear in the original program, ϕ's left-hand sides (LHSs) are referred to as virtual definitions and ϕ's right-hand sides (RHSs) are referred to as virtual uses. The goal of the method is to identify the definitions in the original program, referred to as real definitions, that will be used one and only one time during execution along any possible control flow path. This property is called single-use.

To facilitate the analysis of the single-use property, another factoring of the definition-use edges is applied. Since SSA has already factored definition-use edges at merge points, this new factoring is applied at control flow split (or divergence) points. To represent this factoring, λ is introduced at program points that diverge to different paths, each with its own uses. This process amounts to building another form of representation on top of the constructed SSA form, called SSU form. Since SSU is actually the dual of SSA, the method to construct an SSU form is derived from the method to construct an SSA form based on this duality.

In an SSU form, each use is assigned a unique SSU version, annotated with superscripts in this disclosure; each use post-dominates all the definitions that reach it, implying that each definition can reach at most one use of the same version in an SSU form, and definitions are annotated with the SSU versions of the uses that they reach; and λ is of the form λ(x¹, x²)=x³ with multiple definitions on the LHS and the single use on the RHS establishing a new SSU version. Each λ LHS definition corresponds to one diverging path. When a diverging path does not lead to any use, its corresponding λ LHS definition is specified as ⊥.

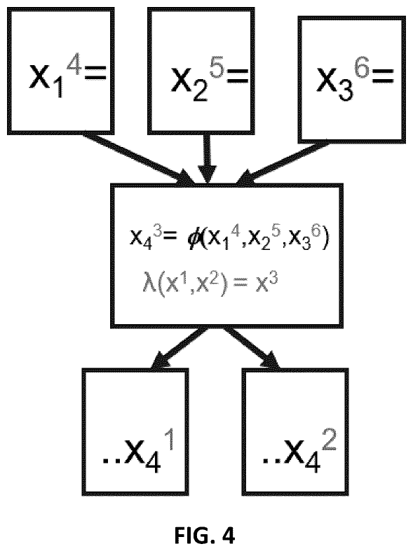

For each occurrence of the SSA variable, its SSA version and SSU version are independent, as shown in FIG. 4. Because λ is inserted after SSA has been constructed, the variables appearing in the A function do not and need not have SSA versions. The λ function plays the role of propagating the single-use property via an SSU graph. An SSA variable can have no SSU version, which occurs when the SSA variable has no use.

FIG. 4 illustrates an SSU form constructed on top of an SSA form, according to an embodiment. In the figure, SSA versions are shown in subscripts and SSU versions are shown in superscript.

Referring to FIG. 4, the SSA versions x₁, x₂, and x₃ feed into a ϕ function (x₁,x₂,x₃)=x₄. This ϕ function establishes a new SSA version x₄ which then diverges into two paths, each of which has a use of x₄.

The λ function in an SSU form plays its role at the split points, where it captures the presence or absence of further uses among the divergent paths. Each LHS definition in the λ function corresponds to a diverging path, ensuring that the non-single-use property is accurately tracked and propagated. The variables appearing in the λ function do not have SSA versions.

Accordingly, the present disclosure provides a method that may globally broadcast a property that is discovered locally by modeling it as a data flow propagation problem over a directional flow graph (e.g., SSA and SSU). As described below, the present disclosure uses an optimistic method, where any definition in the program is assumed single-use unless proven otherwise.

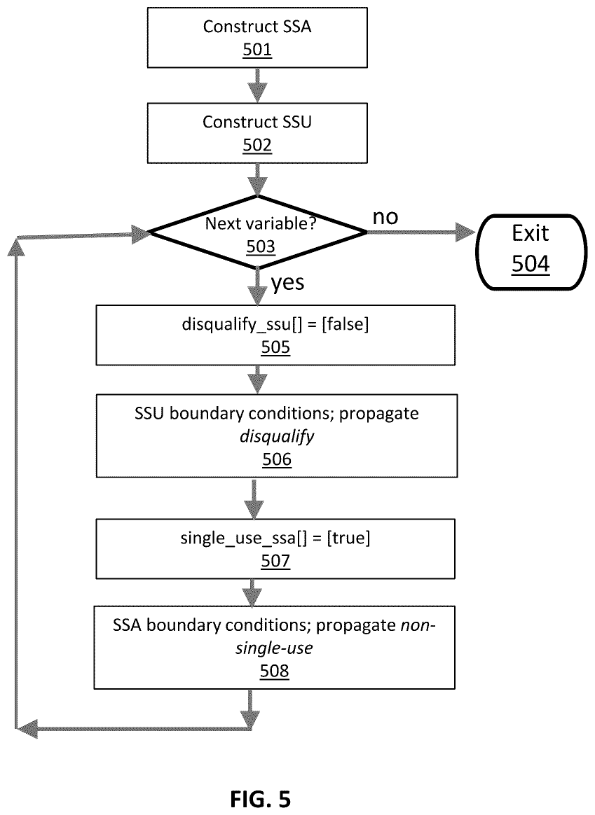

FIG. 5 is a flowchart illustrating a method for identifying dynamic single-use producing definitions in a program, according to an embodiment.

As discussed above, the method of FIG. 5 may be implemented by instructions stored in a computer-readable medium that, when executed, improve the efficiency of the compilation and the performance of the compiled code. One or more steps shown in FIG. 5 may be executed serially or in parallel, or in a different order than is shown. Furthermore, as will be described below with respect to steps 505-508 in pseudocode, one or more of the steps of FIG. 5 may be combined or separated into discrete parts to improve execution.

Referring to FIG. 5, in step 501, SSA is constructed. This may include constructing an SSA form for all the variables in the program and cleaning up. Constructing SSA may include two stages: insertion of ϕ's and renaming. A pass may be made over the program to insert ϕ's at the dominance frontiers of each definition and use of all the variables. This may also include renaming, in which the program code is traversed in a pre-order traversal of the dominator trec. At each definition (including ϕ), a new SSA version is assigned, and a stack of SSA versions is maintained via push and pop operations. At any point in the traversal, the top of the stack gives the SSA version of the last definition, which is to be assigned to any use encountered. When backing up a node in the dominator tree traversal, a reverse traversal pass through the code is simulated, and the stack is popped at each definition.

After renaming, dead store elimination is performed on the SSA form. To perform dead store elimination, all SSA versions are initially marked as dead. For each real use (excluding uses as ϕ operands), the corresponding SSA version is set to live. If an SSA version is a ϕ, liveness is propagated backward via the ϕ operands. The purpose is to identify and delete any ϕ whose LHS has no use and thus plays no role in the solution process. The purpose of this dead store elimination is to remove any non-live definitions so the subsequent steps of the method do not have to deal with them. Alternative embodiments may skip performing dead store elimination and instead enhance the subsequent steps to deal with non-live definitions.

At step 502, SSU is constructed for all the variables. Constructing the SSU may include two stages: insertion of λ's and renaming. The insertion of λ functions may begin with making a pass over the program to insert λ functions at the post-dominance frontiers of each use and definition of the variable. Following the insertion of λ functions, the program code may be traversed in a pre-order traversal of the post-dominator tree, with each block of code being traversed in reverse order. During this traversal, a new SSU version may be assigned to each use encountered, including those on the RHS of λ functions. A stack of SSU versions may be maintained using push and pop operations. At any point in the traversal, the top of the stack gives the SSU version of the last use that is to be assigned to any definition encountered. Once a use has matched with a definition, the definition is pushed onto the stack to prevent its SSU version from being assigned to another definition. When backing up a node in the post-dominator tree traversal, a forward pass through the code may be simulated, and the stack may be popped at each definition and use encountered.

The loop in the flow chart of FIG. 5 processes each variable in the program one by one and independently. At step 503, it checks whether any variable is not yet processed. If there isn't any more unprocessed variables, the method ends at step 504. Otherwise, the method continues to step 505 after picking the next variable to process.

disqualifying_ssu[ ] is an array indexed by SSU versions (as shown with superscript in this disclosure) that stores the disqualifying property for each SSU version. In step 505, the entire disqualifying_ssu[ ] is initialized to false. This means the disqualifying_ssu[ ] array is set to false for all SSU versions. When the disqualifying property is true, it means the use corresponding to the SSU version will disqualify the associated SSA version in the same variable appearance as being single-use. The initialization process means that there is no disqualification at the start.

Following the initialization, in step 506, each SSU version is examined to check whether any of the boundary conditions apply to it. These boundary conditions reflect specific circumstances where the single-use property can be determined or proven to be not true. Whenever a disqualifying property is set to true, the true value is immediately propagated through an SSU graph via the λ functions to other SSU versions. This propagation is performed in both the forward and backward directions, ensuring that the disqualifying information is propagated through the entire program for the variable being processed.

single_use_ssa[ ] is an array indexed by SSA versions (as shown with subscripts in this disclosure) that stores the single-use property, which indicates whether each SSA version is single-use. In step 507, the entire single_use_ssa[ ] array is initialized to true. This means all the definitions for the variable in the program are initially and optimistically assumed to be single-use.

Following the initialization, in step 508, information is transferred from disqualifying_ssu[ ] to single_use_ssa[ ] as the SSA form's boundary conditions. Whenever a single-use property is set to false, the false value is immediately propagated through an SSA graph via the ϕ functions to other SSA versions. The propagation is performed in both the backward and forward directions, ensuring that the non-single-use information is propagated through the entire program for the variable being processed.

By way of example, some or all of the steps of the method of FIG. 5 may be implemented by stored instructions based on pseudocode. The following pseudocode, below, corresponds to steps 505-508, and additional details of these steps are described below.

Step 505. Initialization of disqualifying_ssu[ ]:

| | |
|---|---|
| 505.1 | for xⁱ from x^{l} to x^{p} { |
| 505.2 | disqualifying_ssu[i] ← false |
| | } |

Step 506. SSU boundary conditions and propagation based on λ's

| | |
|---|---|
| 506.1 | for xⁱ from x^{l} to x^{p} { |
| 506.2 | if (xⁱ has no def or |
| 506.3 | (xⁱ is the RHS of a λ) and |
| 506.4 | (one or more of its LHS def's have no SSU version)) { |
| 506.5 | call SetDisqualify(xⁱ) |
| | } |
| | } |

The pseudo-code for the recursive function SetDisqualify( ):

| | |
|---|---|
| 506.6 | SetDisqualify(y^{k}) { |
| 506.7 | if (disqualifying_ssu[k] is true) |
| 506.8 | return; /* marked previously, no need to repeat */ |
| 506.9 | disqualifying_ssu[k] ← true |
| 506.10 | if (y^{k} is RHS of a λ) { |
| | /* forward propagation */ |
| 506.11 | for each λ LHS def z^{j} in the λ { |
| 506.12 | call SetDisqualify(z^{j}) |
| | } |
| | } |
| | /* backward propagation */ |
| 506.13 | for each λ lⁱ where y^{k} appears as LHS def { |
| 506.14 | call SetDisqualify(lⁱ) |
| | } |
| | } |

Step 507. Initialization of single_use_ssa[ ]:

| | |
|---|---|
| 507.1 | for xᵢ from xₗ to xₙ { |
| 507.2 | if (def of xᵢ is not annotated with any SSU version) |
| 507.3 | single_use_ssa[i] ← false |
| 507.4 | else |
| 507.5 | single_use_ssa[i] ← true |
| | } |

Step 508. SSA boundary conditions and propagation based on ϕ's:

| | |
|---|---|
| 508.1 | for xⁱ from x^{l} to x^{p} { |
| 508.2 | if (xₖⁱ is not the RHS of a λ and disqualifying_ssu[i] is true) { |
| 508.3 | call ResetSingleUse(xₖ); |
| | } |
| | } |

The pseudo-code for the recursive function ResetSingleUse( ):

| | |
|---|---|
| 508.4 | ResetSingleUse( xᵢ) { |
| 508.5 | if (single_use_ssa[i] is false) |
| 508.6 | return; /* already set to not single-use, no need to |
| | repeat */ |
| 508.7 | single_use_ssa[i] ← false |
| 508.8 | if (xⱼ is a ϕ def) { |
| | /* backward propagation */ |
| 508.9 | for each ϕ operand yᵢ { |
| 508.10 | call ResetSingleUse(yᵢ) |
| | } |
| | } |
| | /* forward propagation */ |
| 508.11 | for each ϕ zₖ where xᵢ appears as operand { |
| 508.12 | call ResetSingleUse(zₖ) |
| | } |
| | } |

Accordingly, an SSU form may be used to seamlessly identify uses that meet certain disqualifying conditions. Firstly, an SSU form may identify a definition based on any path that leads to zero uses, discovered when a λ operand is ⊥, as shown in line 506.4. This is a disqualifying condition because different paths leading from the control flow split point have a different number of uses. Secondly, an SSU form may identify a use based on any path that is not the first use after a definition, which is discovered whenever an SSU version has zero definitions, as shown in algorithm line 506.2. This works because, in an SSU form, if a definition (from the SSA point of view) leads to more than one use on a path, its uses other than the earliest one will have SSU versions with zero definitions.

These conditions represent boundary conditions in the SSU form. The λ functions serve as the connection nodes in an SSU graph and enable a property to be propagated to all affected SSU versions. For example, when x³ in λ(x¹, x²)=x³ is marked as disqualifying, this property will propagate from x³ to x¹ and x² in the forward direction, as shown in lines 506.11 and 506.12. When x¹ or x² is marked as disqualifying, this property will propagate from x¹ or x² to x³ in the backward direction, as shown in lines 506.13 and 506.14.

In step 507, the focus returns to the SSA form. When a definition is not annotated with any SSU version, it has zero use and cannot be considered single-use, as shown in lines 507.2 and 507.3. Whenever a definition has any of its uses associated with a disqualified SSU version, the definition cannot be considered single-use, as shown in line 508.2. This is the boundary condition in an SSA form. The ϕ functions serve as the connection nodes in an SSA graph. When a definition is marked as non-single-use, this non-single-use property is propagated to all affected SSA versions via the ϕ functions. For instance, when x₄ in x₄ϕ(x₁,x₂,x₃) is marked as non-single-use, this non-single-use property will propagate from x₄ to x₁, x₂, and x₃ in the backward direction, as shown in lines 508.9 and 508.10. When x₁, x₂, or x₃ is marked non-single-use, this property will propagate from x₁, x₂, or x₃ to x₄ in the forward direction, as shown in lines 508.11 and 508.12.

Examples of applying the steps mentioned above will now be provided.

As a first example, referring again to FIG. 4, initially the disqualifying_ssu[ ] array is set to false for all SSU versions in step 505. This means that no SSU version is initially marked as disqualifying. In step 507, the single_use_ssa[ ] array is initialized to true for all SSA versions because they all are annotated with SSU versions. This initialization indicates that all definitions are initially considered to be single-use.

In this example, no boundary conditions are met that would alter the values in disqualifying_ssu[ ]. Specifically, there are no λ operands that are ⊥, and all uses have corresponding definitions. Therefore, during step 506, no SSU versions are marked as disqualifying. Because of the lack of any boundary condition in the SSA form, there are no updates to single_use_ssa[ ] during step 508.

This results in all definitions x₁⁴, x₂⁵, x₃⁶ and their associated uses being identified as single-use.

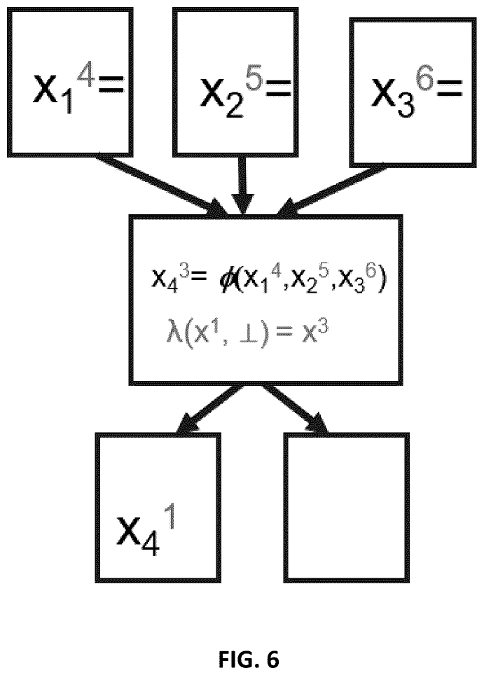

FIG. 6 is a control flow diagram illustrating SSA and SSU forms for the given program, according to an embodiment.

As a second example, disqualifying_ssu[x³] is initialized to true because it has a ⊥ operand, as specified in lines 506.3 and 506.4. This initialization indicates that x³ is disqualifying from single-use due to a divergent path that leads to no use.

During step 506's propagation, the disqualifying status of disqualifying_ssu[x³] propagates to x¹ via the λ function. As a result, disqualifying_ssu[x¹] is also set to true, indicating that x¹ is now disqualified from single-use.

In step 508, via x₄¹, this disqualifying information causes single_use_ssa[x₄] to be set to false. The propagation via the ϕ function in step 508 results in all three definitions x₁⁴, x₂⁵, x₃⁶ in the original program being marked as non-single-use.

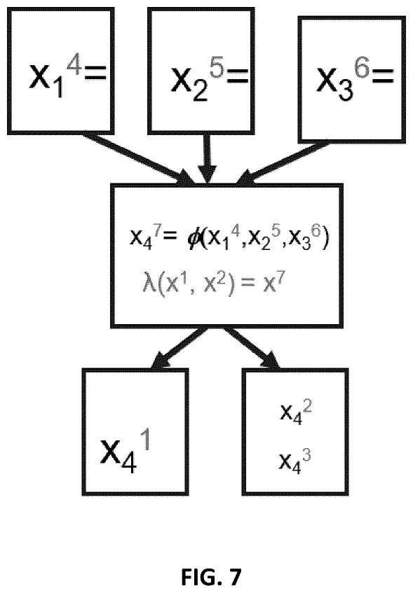

FIG. 7 is a control flow diagram illustrating SSA and SSU forms for the given programs, according to an embodiment.

As a third example, disqualifying_ssu[x³] is set to true because it has no definition, as specified in line 506.2. This initialization indicates that x³ is disqualifying.

During step 508, via x₄³, the disqualifying information causes single_use_ssa[x₄] to be set to false. The propagation via the ϕ function in step 508 results in all three definitions x₁, x₂, and x₃ being marked as non-single-use.

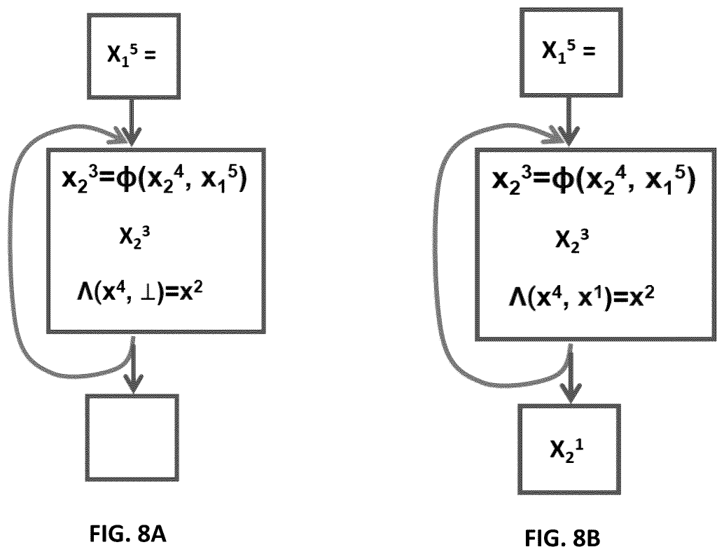

FIGS. 8A-8B are control flow diagrams illustrating SSA and SSU forms for the given programs, according to various embodiments.

As a fourth example, referring to FIG. 8A, there is no use after the loop exit, resulting in a ⊥ for one of the λ definition operands. This ⊥ renders disqualifying_ssu[x²] true in lines 506.3 and 506.4, which indicates that x² is disqualifying due to a divergent path leading to no use.

During step 506's propagation, the disqualifying status of disqualifying_ssu[x²] propagates to x⁴ via the λ function. As a result, disqualifying_ssu[x⁴] is set to true, indicating that x⁴ is now disqualifying from single-use.

In step 508, via x₂⁴, the disqualifying information causes single_use_ssa[x₂] to be set to false. The propagation via the ϕ function in step 508 results in the definition x₁ being marked as non-single-use.

Thus, the method identifies that the definition in FIG. 8A is non-single-use due to the disqualifying conditions propagated through both SSU and SSA forms.

As a fifth example, referring to FIG. 8B, disqualifying_ssu[x²] is set to true in lines 506.2 because it has no def. This indicates that x² is disqualifying from single-use.

During step 506's propagation, the disqualifying status of x² propagates to x⁴ via the λ function. As a result, disqualifying_ssu[x⁴] is set to true, indicating that x⁴ is also disqualifying from single-use.

In step 508, via x₂⁴, the disqualifying information in x⁴ causes single_use_ssa[x₂] to be set to false. The propagation via the ϕ function in step 508 results in the definition x₁ being marked as non-single-use.

Thus, the method identifies that the definition in FIG. 8B are non-single-use due to the disqualifying conditions propagated through both SSU and SSA forms.

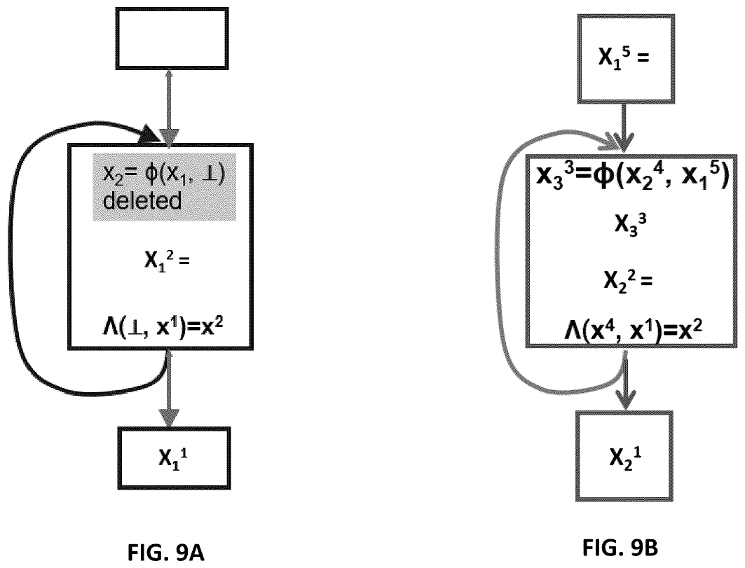

FIGS. 9A-9B are control flow diagrams illustrating SSA and SSU forms for the given programs, according to various embodiments.

As a sixth example, referring to FIG. 9A, the only ϕ inserted in step 501 during SSA construction was deleted in the dead store elimination performed in step 501. The only use of the definition inside the loop is after the loop exit. disqualifying_ssu[x²] is set to false in lines 506.3 and 506.4 because it is the RHS of a λ and one of its LHS definitions has no SSU version. Via x₁², x² causes single_use_ssa[x₁] to be set to false in lines 508.2 and 508.3.

Thus, the method determines that the definition inside the loop in FIG. 9A is not single-use.

As a seventh example, referring to FIG. 9B, after initializing the disqualifying_ssu[ ] array to false for all SSU version in step 505, there is no boundary condition found in step 506 because all the SSU versions have definitions and there is no ⊥ operand in any λ. This indicates that there are no disqualifying conditions present.

In step 507, single_use_ssa[ ] is initialized to true for all SSA versions because all SSA versions have SSU versions. In step 508, because there is no disqualifying SSU version, there is no boundary condition to reset any element of single_use_ssa[ ] to false. Thus, the method identifies that all the definitions in the seventh example are single-use.

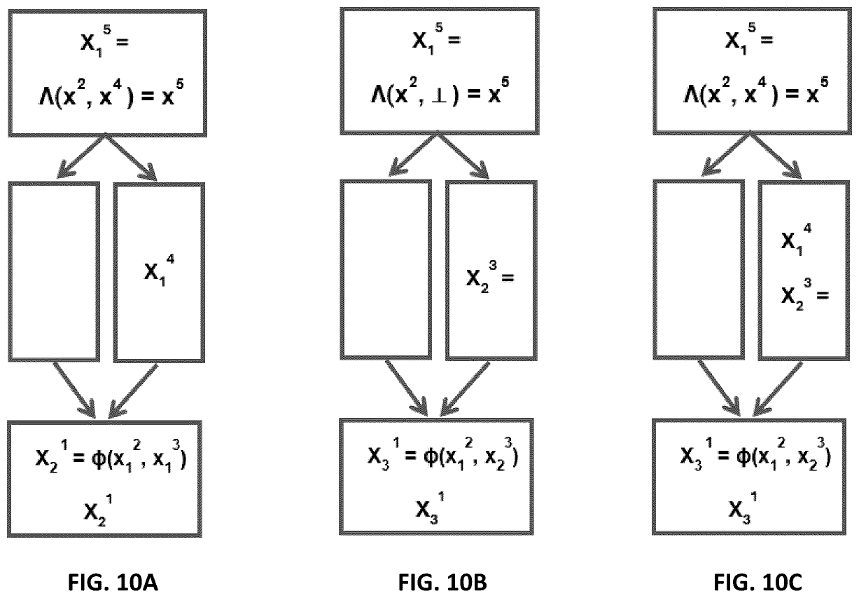

FIGS. 10A-10C are control flow diagrams illustrating SSA and SSU forms for the given programs, according to various embodiments. The examples shown in FIGS. 10A-10C are based on if-then-else code with a definition before them.

As an eighth example, referring to FIG. 10A, x₁³ has no definition, so disqualifying_ssu[x³] is set to true in step 506, as specified in line 506.2.

During step 508, via x₁³, this disqualifying information causes single_use_ssa[x₁] to be set to false, as specified in lines 508.2 and 508.3.

As a ninth example, referring to FIG. 10B, disqualifying_ssu[x⁵] is initialized to true because its λ function has a ⊥ operand, as specified in lines 506.3 and 506.4.

During step 508, via x₁⁵, this disqualifying information causes single_use_ssa[x₁] to be set to false, as specified in lines 508.2 and 508.3. The propagation via the ϕ function results in the definition x₂ being marked as non-single-use also.

As a tenth example, referring to FIG. 10C, the disqualifying_ssu[ ] array is initialized to false for all SSU versions in step 505, and because all the SSU versions have definitions and there is no ⊥ operand, there is no boundary condition found in step 506.

Since all SSA versions have SSU versions, single_use_ssa[ ] is initialized to true for all SSA versions in step 507. During step 508, because disqualifying_ssu[ ] has no true value, there is no boundary condition to reset single_use_ssa[ ] for any SSA version.

Thus, the method identifies that all the definitions in the tenth example are single-use. This example demonstrates how the absence of disqualifying conditions and the presence of SSU versions ensure that definitions are accurately marked as single-use.

Construction of an SSA form will now be described. It should be noted that this is not the only method to construct an SSA form. Alternative methods can be applied. The method described here is the original method and is most popular.

To construct an SSA form, dominance relationships among the basic blocks should be pre-computed in the CFG. This includes constructing the dominator tree for the CFG and determining the dominance frontiers. For a given CFG, there may be only one dominator trec. The dominator tree represents all nodes in the CFG in the form of a tree where each node's children are those nodes that it immediately dominates, with the start node of the CFG as the root of the tree. The ordering of the children in each node may be swapped in a dominator tree, and such re-ordering may not affect the utility of a constructed SSA form. The dominance frontiers of a node are the nodes just outside the region in the CFG that the node dominates. Regardless of the order of the children for a node of a dominator tree, the dominance frontier for the node should appear the same.

The construction of an SSA form involves two main steps. First, ϕ functions are inserted by making a pass over the program. When a definition or use of the variable is encountered, ϕ functions are inserted at the dominance frontiers of the current block. Unlike standard SSA, where only definitions trigger ϕ insertion, in this application, uses also cause ϕ functions to be inserted at their dominance frontiers. Because ϕ itself is a definition, cach inserted ϕ will in turn cause additional ϕ functions to be inserted at its dominance frontiers.

The second step is renaming. A pre-order traversal of the dominator tree is performed to assign SSA versions to each occurrence of the variables. At each basic block, the statements or instructions are traversed in execution order. A stack of SSA versions is maintained for cach variable, ensuring that the top of the stack always provides the current SSA version to be assigned when any use of the variable is encountered during the traversal. At each definition, including o functions, a new SSA version is assigned to the variable being defined, and the new SSA version is pushed onto the top of the stack. When backing up a node in the dominator tree traversal, the stack is popped by simulating a reverse execution of the definitions in the basic block to ensure that the top of the stack still gives the current SSA version at the backed-up program position.

Construction of an SSU form will now be described.

As discussed above, SSU can be thought of as the dual of SSA, focusing on the variables' uses as opposed to their definitions. To create an SSU form, the post-dominance relationships among the basic blocks should be pre-computed in the CFG, which includes constructing the post-dominator tree and determining the post-dominance frontiers. For a given CFG, there is only one post-dominator tree. The post-dominator tree represents all nodes in the CFG in the form of a tree where each node's children are those nodes that it immediately post-dominates, with the exit node of the CFG as the root of the tree. The post-dominance frontiers of a node are the nodes just outside the region in the CFG that the node post-dominates.

The construction of an SSU form involves two main steps. First, λ functions are inserted by making a pass over the program. When a definition or use of the variable is encountered, a λ function is inserted at the post-dominance frontiers of the current block.

The second step is renaming. A pre-order traversal of the post-dominator tree is performed to assign SSU versions to each occurrence of the variable. At each basic block, the statements or instructions are traversed in reverse order (opposite to execution order). A stack of SSU versions is maintained for each variable, ensuring that the top of the stack always provides the current SSU version to be assigned when any definition of the variable is encountered during the traversal. At each use, including the RHS of any λ function, a new SSU version is assigned to the variable being referenced, and the new SSU version is pushed onto the top of the stack. At a def, if the top of the stack is a use, its SSU version is assigned to the def, and the def is pushed to the top of the stack; if the top of the stack is not a use, the def will not be assigned any SSU version. When backing up a node in the post-dominator tree traversal, the stack is popped by simulating a forward execution of the uses and definitions in the basic block to ensure that the top of the stack still gives the current SSU version at the current program position.

The computational complexity of steps 505-508 in this method is linear. Steps 505 and 506 have linear complexity with respect to the number of SSU versions. Steps 507 and 508 have linear complexity with respect to the number of SSA versions.

The only non-linear aspect of this approach is in the construction of SSA and SSU forms. The dominance and post-dominance prerequisites for SSA and SSU should already exist in the compiler, as they are used for many other compilation tasks in modern compilers. These properties are attributes of the CFG and are unrelated to the program variables.

To avoid repeated traversals over the program code, SSA and SSU construction should be performed for all program variables simultaneously before applying the four main steps, 505-508, of this method.

The complexity of SSA construction is well understood. In the SSA construction process, the only non-linear step is the ϕ insertion step. Most compilers accept this non-linearity in the construction of SSA. Alternative methods to construct SSA exist that can reduce the complexity to close to linear, but they may take more effort to implement. Since SSU is the dual of SSA, the complexity of SSU construction corresponds to that of SSA.

Existing technologies are capable of detecting single-use within single basic blocks. These technologies can be augmented to detect some, but not all, dynamic single-use cases across basic blocks. Examples of such augmentation include the case of a definition outside a loop and a use inside the loop, and the scenario where the use is inside the “then” and “else” blocks of if-then-else constructs.

In the case of a definition outside a loop and a use inside the loop, as illustrated in FIG. 8A, this scenario represents static single-use but not dynamic single-use, since the use in the loop body can occur multiple times. Without using the method introduced in this application, one way to detect multiple single-use cases across basic blocks would be to disqualify definitions when the use is inside a loop and the definition is outside. While possible, this approach relies on performing loop analysis, which requires the compiler to do more work and increases its overhead. If not done carefully, the scenario in FIG. 8B may also be incorrectly disqualified.

In the scenario where the uses are inside the “then” and “else” blocks of if-then-else constructs, as shown in FIG. 4, and the values are defined before the if-then-else construct, technologies may use data flow analysis to propagate liveness information across basic blocks in the CFG. However, such data flow analysis only provides information on the presence or absence of uses, and not the number of their occurrences. Without further analysis of the code, no definite answer regarding dynamic single-use can be determined.

For cross-basic-block definition-use cases, without the method disclosed herein, as previously mentioned, an alternative is to resort to pattern matching over the CFG for the plurality of occurrence patterns that satisfy dynamic single use. This approach typically starts with the common and frequently occurring patterns. To ensure broader coverage, more patterns are added over time, which can be a never-ending process. Adding more patterns also becomes counter-productive because it slows down the compilation due to the need to match more patterns and increases the compiler's storage requirements.

The method described herein overcomes these limitations by providing a comprehensive approach to accurately and efficiently track and propagate the single-use property throughout the program.

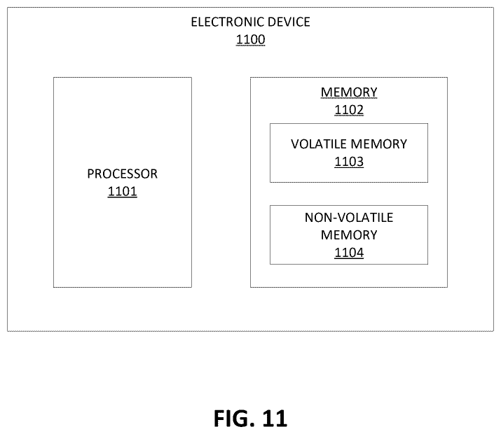

FIG. 11 illustrates a block diagram of an electronic device configured to implement the method and system for identifying dynamic single-use producing definitions in a program, according to an embodiment.

Referring to FIG. 11, the electronic device 1100 includes a processor 1101 and a memory 1102. The memory 1102 comprises both volatile memory 1103 and non-volatile memory 1104.

The processor 1101 is a hardware component that executes instructions to perform the method described herein. It is capable of performing the various computational tasks required for constructing an SSA form and an SSU form, propagating single-use disqualifying conditions and non-single-use conditions, and identifying single-use definitions. The processor 1101 may be a central processing unit (CPU), a graphics processing unit (GPU), or any other type of specialized processor designed to handle specific computational tasks efficiently.

The memory 1102, which includes volatile memory 1103 and non-volatile memory 1104, is used to store data and instructions that are executed by the processor 1101. Volatile memory 1103, such as random-access memory (RAM), provides fast temporary storage for instructions and data that are actively being used by the processor 1101. Non-volatile memory 1104, such as flash memory or a solid-state drive (SSD), provides persistent storage for the instructions and data necessary for implementing the method described.

Some or all of the embodiments described in this application improve upon common hardware components in a computer or processor by optimizing the process of identifying dynamic single-use producing definitions, which enhances overall system performance and efficiency. Specifically, embodiments disclosed herein leverage SSA and SSU forms to perform sophisticated data flow analysis, reducing compile-time overhead and increasing the accuracy of single-use identification.

In this block diagram of FIG. 11, SSA form and SSU form construction modules can be implemented as software modules stored in the non-volatile memory 1104 and loaded into the volatile memory 1103 for execution by the processor 1101. The propagation of single-use disqualifying conditions and single-use conditions, as well as the identification of single-use definitions, are processes carried out by the processor 1101, utilizing data stored in both volatile memory 1103 and non-volatile memory 1104.

This configuration ensures that the electronic device 1100 is capable of performing the necessary computations and storage operations efficiently. The described method enhances the functionality of the processor 1101 by providing a more efficient and accurate mechanism for increasing the speed of program execution and reducing power consumption, which can be particularly beneficial in applications requiring high performance and reliability.

By incorporating these improvements, the solutions described herein provide significant advantages over conventional systems, making it a valuable addition to the field of compiler optimization and data flow analysis in computer programs. This ensures that the electronic device 1100 performs tasks in a manner that is both effective and efficient, thereby leveraging the hardware components to their fullest potential.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.c., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple compact disks (CDs), disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
constructing a static single assignment (SSA) form and a static single use (SSU) form for a program;
setting a single-use disqualifying property locally for each SSU version, and propagating the single-use disqualifying property both forward and backward on an SSU graph uniquely formed from the constructed SSU form so it becomes a global property;
transferring results from the SSU form to the SSA form to set a single-use property locally for each SSA version based on an occurrence of any use being associated with a disqualifying SSU version;
performing data flow analysis on an SSA graph uniquely formed from the constructed SSA form so the single-use property becomes a global property to identify one or more definitions as dynamic single-use for variables in the program; and
generating computer-readable instructions for executing the program based on the one or more definitions identified as dynamic single use for the variables in the program,
wherein the one or more definitions identified as dynamic single-use has a defined value used exactly one time during execution of the program.

2. The method of claim 1, wherein constructing the SSA form includes inserting function ϕ's at dominance frontiers of definitions and uses and renaming variable definitions and uses by assigning SSA versions through a pre-order traversal of a dominator tree formed from a control flow graph (CFG).

3. The method of claim 1, wherein the SSU form is constructed on top of the SSA form, and
wherein constructing the SSU form includes inserting function λ's at post-dominance frontiers of definitions and uses and renaming variable definitions and uses by assigning SSU versions through a pre-order traversal of a post-dominator tree formed from a control flow graph (CFG).

4. The method of claim 1, further comprising:
initializing a single-use disqualifying array, having one entry for each SSU version, to false for all SSU versions to track the single-use disqualifying property for each entry in the single-use disqualifying array; and
initializing a single-use qualifying array, having one entry for each SSA version, to track a single-use qualifying property, and setting each entry's initial value to true if the definition of its corresponding SSA version has an annotated SSU version, and to false if it does not.

5. The method of claim 4, further comprising setting the single-use disqualifying array to true for SSU versions with no definition in the SSU form or for SSU versions that are right hand side (RHS) of λ's with one or more ⊥ operands.

6. The method of claim 1, wherein propagating the single-use disqualifying property further comprises propagating the single-use disqualifying property in the SSU form by traversing the SSU graph and updating a single-use disqualifying array based on an operator inserted at points where control flow diverges, and
wherein performing the data flow analysis further comprises traversing the SSA graph and updating a single-use qualifying array based on an operator inserted at points where control flow converges.

7. The method of claim 1, wherein the method is performed iteratively for the variables in the program and identifies whether each of the definitions in the program is dynamic single-use.

8. An apparatus comprising:
a processor; and
a memory storing instructions that, when executed by the processor, cause the apparatus to:
construct a static single assignment (SSA) form and a static single use (SSU) form for a program;
set a single-use disqualifying property locally for each SSU version, and propagate the single-use disqualifying property both forward and backward on an SSU graph uniquely formed from the constructed SSU form so it becomes a global property;
transfer results from the SSU form to the SSA form to set a single-use property locally for each SSA version based on an occurrence of any use being associated with a disqualifying SSU version;
perform data flow analysis on an SSA graph uniquely formed from the constructed SSA form so the single-use property becomes a global property to identify one or more definitions as dynamic single-use for variables in the program; and
generate computer-readable instructions for executing the program based on the one or more definitions identified as dynamic single use for the variables in the program,
wherein the one or more definitions identified as dynamic single-use has a defined value used exactly one time during execution of the program.

9. The apparatus of claim 8, wherein constructing the SSA form includes inserting function ϕ's at dominance frontiers of definitions and uses and renaming variable definitions and uses by assigning SSA versions through a pre-order traversal of a dominator tree formed from a control flow graph (CFG).

10. The apparatus of claim 8, wherein the SSU form is constructed on top of the SSA form, and
wherein constructing the SSU form includes inserting function λ's at post-dominance frontiers of definitions and uses and renaming variable definitions and uses by assigning SSU versions through a pre-order traversal of a post-dominator tree formed from a control flow graph (CFG).

11. The apparatus of claim 8, wherein the memory further stores instructions that, when executed by the processor, cause the apparatus to:
initialize a single-use disqualifying array, having one entry for each SSU version, to false for all SSU versions to track the single-use disqualifying property for each entry in the single-use disqualifying array; and
initialize a single-use qualifying array, having one entry for each SSA version, to track a single-use qualifying property, and setting each entry's initial value to true if the definition of its corresponding SSA version has an annotated SSU version, and to false if it does not.

12. The apparatus of claim 11, wherein the memory further stores instructions that, when executed by the processor, cause the apparatus to set the single-use disqualifying array to true for SSU versions with no definition in the SSU form or for SSU versions that are right-hand side (RHS) of λ's with one or more ⊥ operands.

13. The apparatus of claim 8, wherein propagating the single-use disqualifying property further comprises propagating the single-use disqualifying property in the SSU form by traversing the SSU graph and updating a single-use disqualifying array based on an operator inserted at points where control flow diverges, and
wherein performing the data flow analysis further comprises traversing the SSA graph and updating a single-use qualifying array based on an operator inserted at points where control flow converges.

14. The apparatus of claim 8, wherein the memory further stores instructions that, when executed by the processor, cause the apparatus to iteratively perform the method for the variables in the program and identify whether each of the definitions in the program is dynamic single-use.

15. A system comprising:
a processor configured to execute instructions to:
construct a static single assignment (SSA) form and a static single use (SSU) form for a program;
set a single-use disqualifying property locally for each SSU version, and propagate the single-use disqualifying property both forward and backward on an SSU graph uniquely formed from the constructed SSU form so it becomes a global property;
transfer results from the SSU form to the SSA form to set a single-use property locally for each SSA version based on an occurrence of any use being associated with a disqualifying SSU version;
perform data flow analysis on an SSA graph uniquely formed from the constructed SSA form so the single-use property becomes a global property to identify one or more definitions as dynamic single-use for variables in the program; and
generate computer-readable instructions for executing the program based on the one or more definitions identified as dynamic single use for the variables in the program,
wherein the one or more definitions identified as dynamic single-use has a defined value used exactly one time during execution of the program.

16. The system of claim 15, wherein constructing the SSA form includes inserting function ϕ's at dominance frontiers of definitions and uses and renaming variable definitions and uses by assigning SSA versions through a pre-order traversal of a dominator tree formed from a control flow graph (CFG).

17. The system of claim 15, wherein the SSU form is constructed on top of the SSA form, and
wherein constructing the SSU form includes inserting function λ's at post-dominance frontiers of definitions and uses and renaming variable definitions and uses by assigning SSU versions through a pre-order traversal of a post-dominator tree formed from a control flow graph (CFG).

18. The system of claim 15, wherein the processor is further configured to:
initialize a single-use disqualifying array, having one entry for each SSU version, to false for all SSU versions to track the single-use disqualifying property for each entry in the single-use disqualifying array; and
initialize a single-use qualifying array, having one entry for each SSA version, to track a single-use qualifying property, and setting each entry's initial value to true if the definition of its corresponding SSA version has an annotated SSU version, and to false if it does not.

19. The system of claim 18, wherein the processor is further configured to set the single-use disqualifying array to true for SSU versions with no definition in the SSU form or for SSU versions that are right-hand side (RHS) of λ's with one or more ⊥ operands.

20. The system of claim 15, wherein propagating the single-use disqualifying property further comprises propagating the single-use disqualifying property in the SSU form by traversing the SSU graph and updating a single-use disqualifying array based on an operator inserted at points where control flow diverges, and
wherein performing the data flow analysis further comprises traversing the SSA graph and updating a single-use qualifying array based on an operator inserted at points where control flow converges.
